(19) United States
(12) Patent Application Publication
(10) Pub. No.: US 2011/0148934 A1
(43) Pub. Date: Jun. 23, 2011

(54) Method and Apparatus for Adjusting Position of an Information Item

(75) Inventor: Mikko Antero Nurmi, Tampere (FI)

(73) Assignee: NOKIA CORPORATION, Espoo (FI)

(21) Appl. No.: 12/641,790

(22) Filed: Dec. 18, 2009

(51) Int. Cl. G09G 5/00

(52) U.S. Cl. 345/672

(57) ABSTRACT

An apparatus, comprising a processor, memory including computer program code, the memory and the computer program code configured to, working with the processor, cause the apparatus to perform at least the following, identify a first information item positioned coincidingly with a determined position of a display boundary, determine at least one split region candidate, select a split region from the at least one split region candidate, and adjust position of the first information item so that the selected split region coincides with the determined position of the display boundary is disclosed.

### TECHNICAL FIELD

The present application relates generally to adjusting an information item.

### BACKGROUND

There has been a recent surge in the use of electronic devices that display information such as images, text, and video. The devices may display multiple types of information simultaneously.

### SUMMARY

Various aspects of examples of the invention are set out in the claims.

An apparatus, comprising a processor, memory including computer program code, the memory and the computer program code configured to, working with the processor, cause the apparatus to perform at least the following, identify a first information item positioned coincidingly with a determined position of a display boundary, determine at least one split region candidate, select a split region from the at least one split region candidate, and adjust position of the first information item so that the selected split region coincides with the determined position of the display boundary is disclosed.

A method, comprising identifying with a processor a first information item positioned coincidingly with a determined position of a display boundary, determining with a processor at least one split region candidate, selecting with a processor a split region from the at least one split region candidate, and adjusting with a processor position of the first information item so that the selected split region coincides with the determined position of the display boundary is disclosed.

A computer program product comprising a computer-readable medium bearing computer program code embodied therein for use with a computer, the computer program code comprising code for identifying a first information item positioned coincidingly with a determined position of a display boundary, code for determining at least one split region candidate, code for selecting a split region from the at least one split region candidate, and code for adjusting position of the first information item so that the selected split region coincides with the determined position of the display boundary is disclosed.

A computer-readable medium encoded with instructions that, when executed by a computer, perform: identifying a first information item positioned coincidingly with a determined position of a display boundary, determining at least one split region candidate, selecting a split region from the at least one split region candidate, and adjusting position of the first information item so that the selected split region coincides with the determined position of the display boundary is disclosed.

### BRIEF DESCRIPTION OF THE DRAWINGS

For a more complete understanding of embodiments of the invention, reference is now made to the following descriptions taken in connection with the accompanying drawings in which:

FIG. 1 is a diagram illustrating an example of information items according to an example embodiment;

FIGS. 2A-2D are diagrams illustrating examples of information items according to an example embodiment;

FIG. 3 is a diagram illustrating an example of split region candidates according to an example embodiment;

FIGS. 4A-4C are diagrams illustrating examples adjusted information items according to an example embodiment;

FIG. 5 is a flow diagram showing a set of operations for adjusting an information item according to an example embodiment;

FIG. 6 is a flow diagram showing a set of operations for adjusting an information item according to an example embodiment; and

FIG. 7 is a block diagram showing an apparatus according to an example embodiment.

### DETAILED DESCRIPTION OF THE DRAWINGS

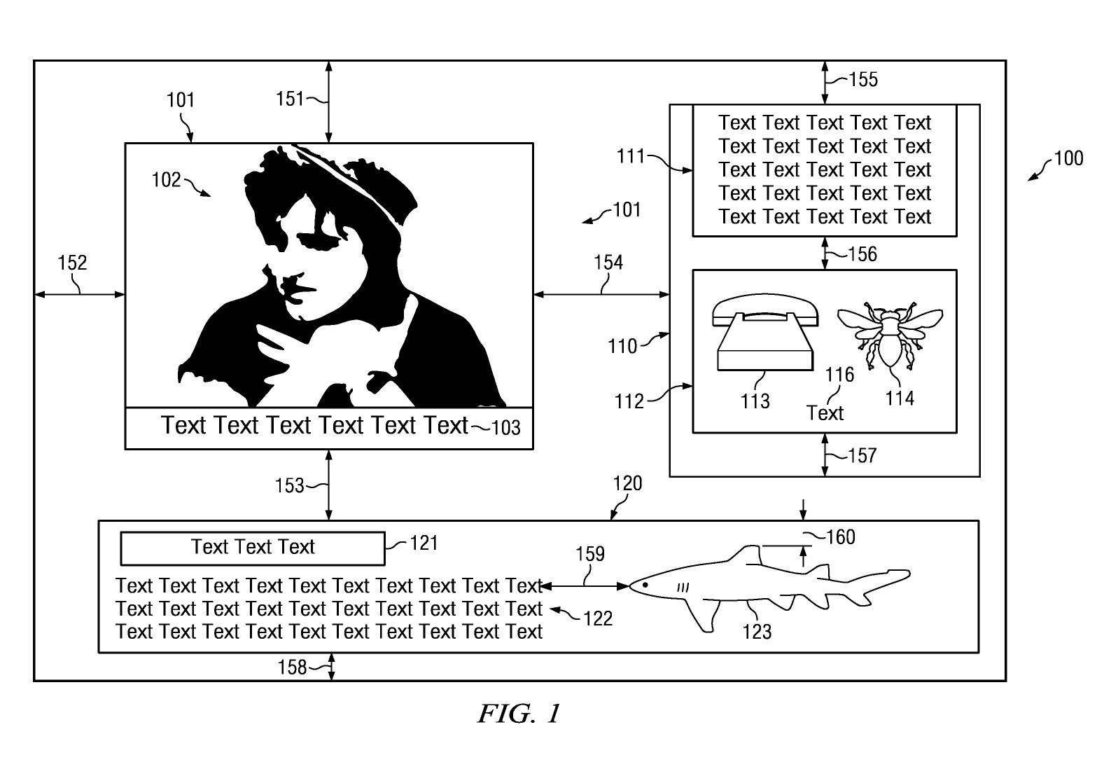

An embodiment of the invention and at least some of its potential advantages are understood by referring to FIGS. 1 through 7 of the drawings.

In an example embodiment, a user may desire to view information on a display so that certain information is either displayed in its entirety or omitted from being displayed. For example, a user may desire to view an image in its entirety instead of a partial image that is obstructed by clipping at a display boundary, or spanning multiple displays. The user may desire information items to be adjusted to avoid partially displaying certain information and/or having certain information span multiple displays. Such adjustment may improve the coherency of the information viewed by the user.

FIG. 1 is a diagram illustrating an example of information items according to an example embodiment. The example of FIG. 1 is merely an example of information items and possible positions associated with information items, and does not limit the invention. For example, information items may differ in type, size, position, color, orientation, and/or the like.

An information item may relate to image information, text information, video information, widget information, icon information, and/or the like. Text information may relate to a character, a group of characters, a word, a group of words, a line of text, a column of text, a block of text, and/or the like. An information item may comprise one or more other information items. For example, an information item may comprise an image information item and text information item. In such an example, the text information item may relate to a caption associated with the image information item. In another example, an information item may comprise two blocks of text information.

In the example of FIG. 1, information item 100 comprises information items 101, 110, and 120. Information item 101 comprises video information item 102 and text information item 103. Information item 110 comprises information item 111 and information item 112. Information item 111 comprises text information items. Information item 112 comprises icon information items 113 and 114, and text information item 116. Information item 120 comprises information text item 121, text information item 122, and image information item 123.

A space region relates to distances between information items. In an example embodiment, a space region is represented by a specified value governing space between information items. In another example embodiment, information items are positioned without direct specification of space regions. In such an embodiment, space regions result from, and/or may be determined by, relative positioning of information items. For example, space region 151 relates to a span between the top of information item 101 and the top of information item 100. Information item 152 relates to a span between the left of information item 100 and the left of information item 101. Space region 153 relates to a span between information item 101, and information item 120. Space region 154 relates to a span between the right of information item 101 and the left of information item 110. Space region 155 relates to a span between the top of information item 100 and the top of information item 110. Although space regions 151 and 155 appear similar in the example of FIG. 1, they may differ depending on relative positions of information items. There is no space region between the top of information item 110 and the top of information item 111. Space region 156 relates to a span between the bottom of information item 111 and the top of information item 112. Space region 157 relates to a span between the bottom of information item 112 and the bottom of information item 110. Space region 158 relates to a span between the bottom of information item 120 and the bottom of information item 100. Space region 159 relates to a span between the right of text information item 122 and image information item 123. Space region 160 represents a span between the top of image information item 123 and the top of information item 120.

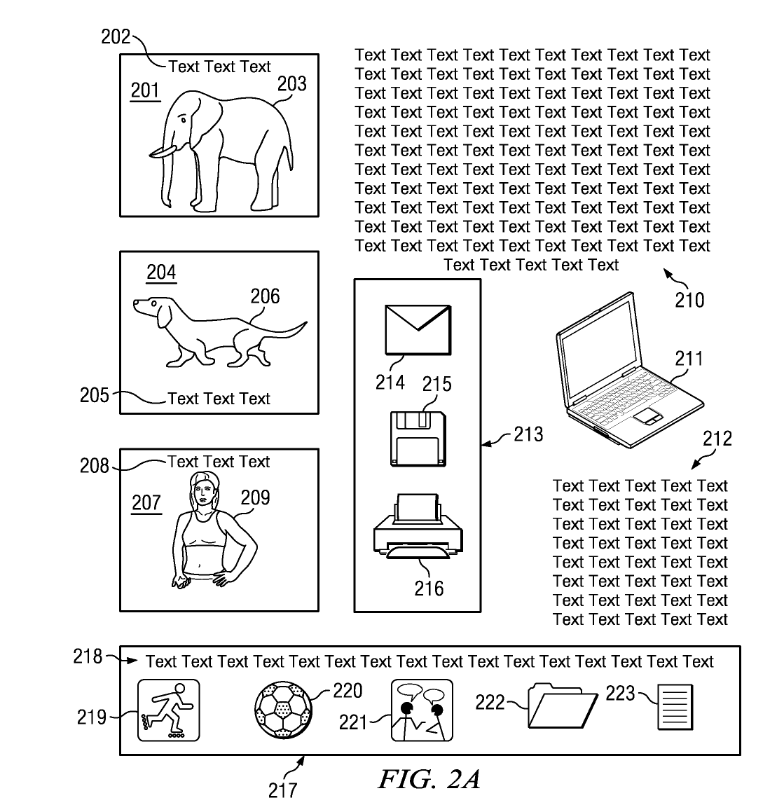

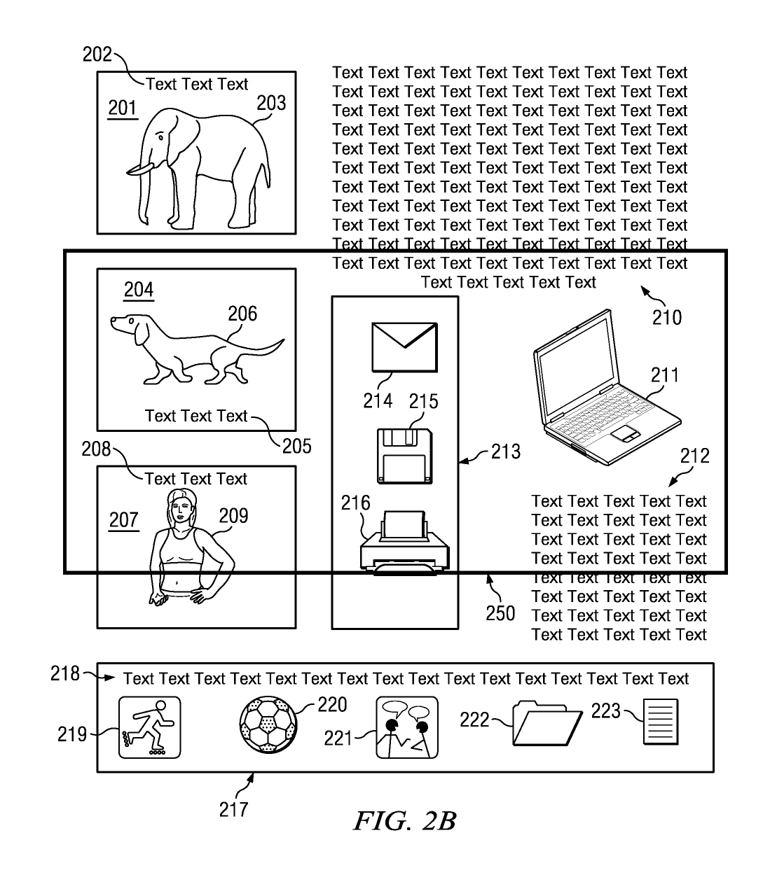

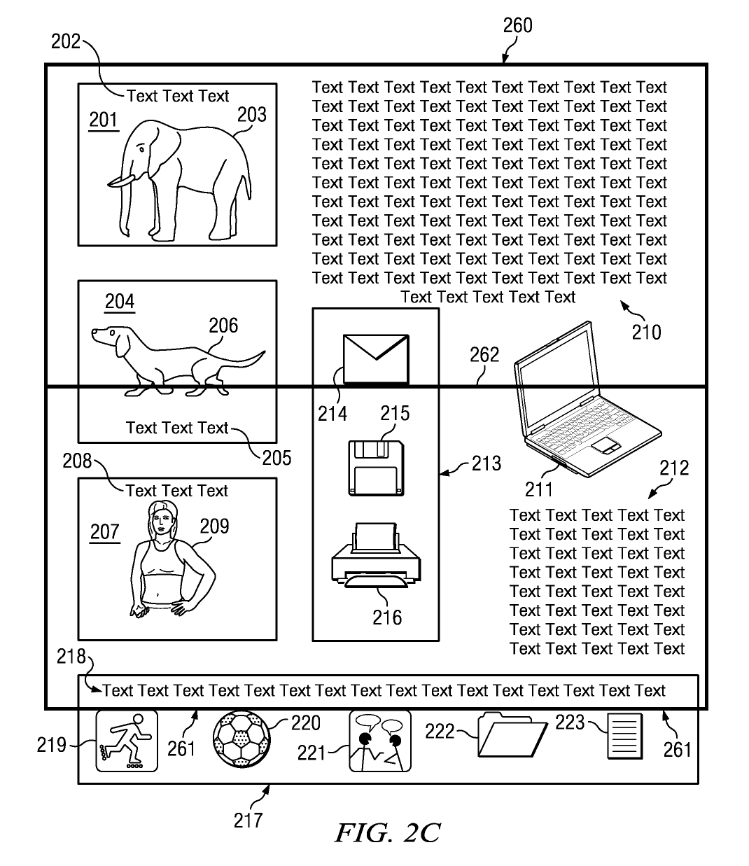

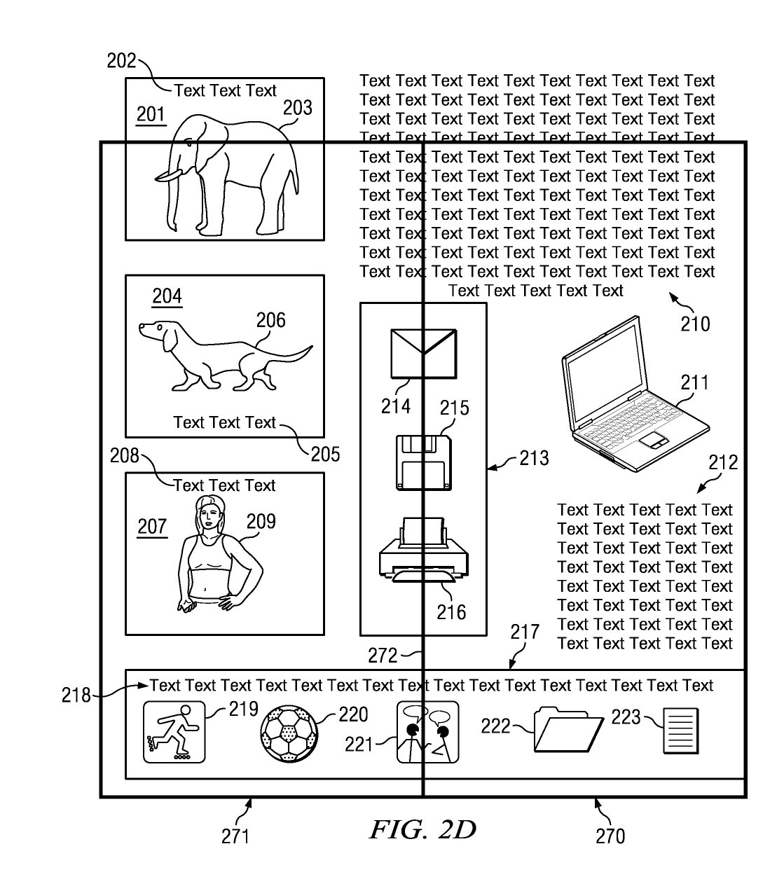

FIGS. 2A-2D are diagrams illustrating examples of information items according to an example embodiment. The example of FIGS. 2A-2D are merely examples of information items and possible positions associated with information items, and do not limit the invention. For example, information items may differ in type, size, position, color, orientation, and/or the like.

FIG. 2A is a diagram illustrating examples of information items according to an example embodiment. Information item 201 comprises text information item 202 and video information item 203. Information item 204 comprises text information item 205 and image information item 206. Information item 207 comprises text information item 208 and image information item 209. Text information 210, image information 211, and text information 212 are not comprised in an information item. Information item 113 comprises icon information items 214, 215, and 216. Information item 217 comprises text information item 218 and icon information items 219-223.

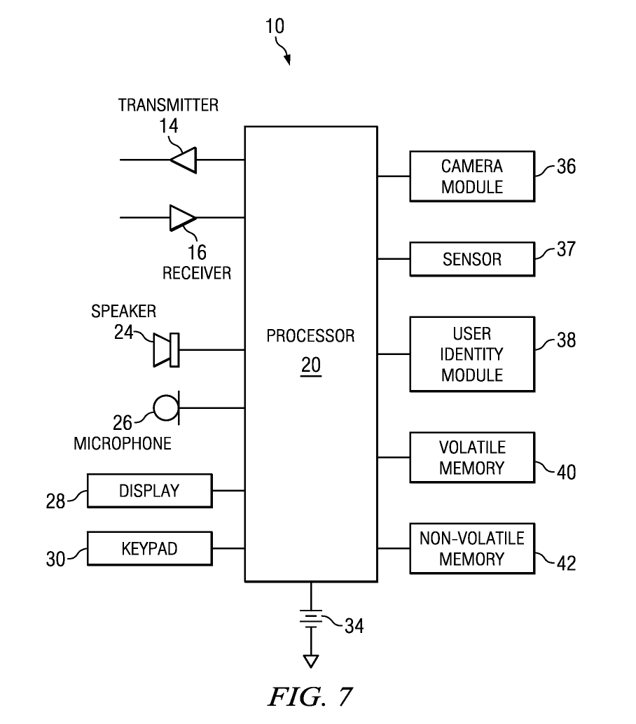

The examples of FIGS. 2B-2D illustrate the information items in relation to one or more display boundary regions. In an example embodiment, the information items within the display boundary regions may be caused to be displayed in whole or in part. For example, a display boundary region may indicate information displayed to a user on a display, such as display 28 of FIG. 7. In such an example, the one or more display boundaries may relate to one or more boundaries of a display, such as display 28 of FIG. 7.

FIG. 2B is a diagram illustrating examples of information items in relation to display boundary region 250 according to an example embodiment. The left display boundary of display boundary region 250 coincides with the space regions to the left of information items 204 and 207. The right display boundary of display boundary region 250 coincides with the space regions to the right of text information item 210, image information item 211, and text information item 212. The top display boundary of display boundary region 250 coincides with text information item 210 and the space region between information item 201 and information item 204. The bottom display boundary of display boundary region 250 coincides with information item 207, image information item 209, information item 213, icon information item 216, and text information item 212.

The examples of FIGS. 2C-2D illustrate the information items in relation to a plurality of display regions. Even though the examples of FIGS. 2C-2D illustrate 2 display boundary regions, an example embodiment may have more than 2 display boundary regions. In addition, the plurality of boundary regions may have at least one coincidental display boundary, as indicated in FIGS. 2C-2D. However, example embodiments may utilize display boundaries that merely partially coincide. Furthermore, example embodiments may utilize display boundaries that do not coincide. In circumstances where boundary regions from more than one display coincide, the coincidental display boundary relates to a display boundary between a plurality of displays, such as display 28 of FIG. 7.

In an example embodiment, an apparatus comprises one or more displays, such as display 28, and the one or more display boundary regions relate to the one or more displays. For example, an apparatus may comprise a plurality of displays in fixed relation to each other, foldable relation to each other, rotatable relation to each other, pivotable relation to each other, and/or the like. For example, an apparatus may comprise 2 displays in foldable relation to each other by having a first housing that comprises a first display, where the first housing is foldably attached to a second housing that comprises a second display.

In an example embodiment, an apparatus may communicate with one or more external displays, and the one or more display boundary regions may relate to the one or more external displays. The external displays may be in fixed relation to each other, foldable relation to each other, rotatable relation to each other, pivotable relation to each other, and/or the like. The external displays may be separately positionable without any attachment between them. For example, the displays may be resting on a desk.

Coincidental or overlapping display boundaries to not imply that the edges of the corresponding displays are in contact. There may be a non-display region between the displays. For example, displays may be separated by an attachment between the displays, housing, space, and/or the like. For example, two foldably related displays may have housing and a foldable attachment between the displays. In another example, three external displays may be positioned so that there is a space between each of the displays.

FIG. 2C is a diagram illustrating examples of information items in relation to display boundary regions 260 and 261 according to an example embodiment. Display boundary 262 relates to the bottom display boundary of display boundary region 260 and the coinciding top display boundary of display boundary region 261. Display boundary 262 relates to a display boundary between two displays. Display boundary 262 coincides with information item 204, image information item 206, information item 213, icon information item 214, and image information item 211. The right, left, and top display boundaries of boundary region 260 coincide with space regions. The right and left display boundaries of display boundary region 261 coincide with space regions. The bottom display boundary of display boundary region 261 coincides with information item 217 and the space region between text information item 218 and icon information items 219-223.

FIG. 2D is a diagram illustrating examples of information items in relation to display boundary regions 270 and 271 according to an example embodiment. Display boundary 272 relates to the left display boundary of display boundary region 270 and the coinciding right display boundary of display boundary region 271. Display boundary 272 relates to a display boundary between two displays. Display boundary 272 coincides with text information item 210, information item 213, icon information items 214-216, information item 217, text information item 218, and icon information item 221. The right and bottom display boundaries of boundary region 270 coincide with space regions. The top display boundary of display boundary region 270 coincides with text information 210. The left and bottom display boundaries of display boundary region 271 coincide with space regions. The top display boundary of display boundary region 271 coincides with information item 201, video information item 203, and text information item 210.

Although the examples of FIGS. 2A-2D illustrate information items arranged in relation to each other, this illustration merely indicates information items and their relative relationships, and does not limit the invention. An apparatus may cause display of one or more of the information items. The apparatus may omit from rendering one or more of the information items. For example, the apparatus may only render an information item that it is causing display of. The illustration of an information item outside of a display boundary is provided merely to indicate relative relationships among information items, and does not indicate anything regarding rendering and/or display.

In an example embodiment, an apparatus determines a split region associated with one or more information items so that the split region may coincide with one or more display boundaries after adjusting one or more information items.

In an example embodiment, an apparatus selects a split region from one or more split region candidates. For example, an apparatus may determine a plurality of possible split regions to associate with split region candidates.

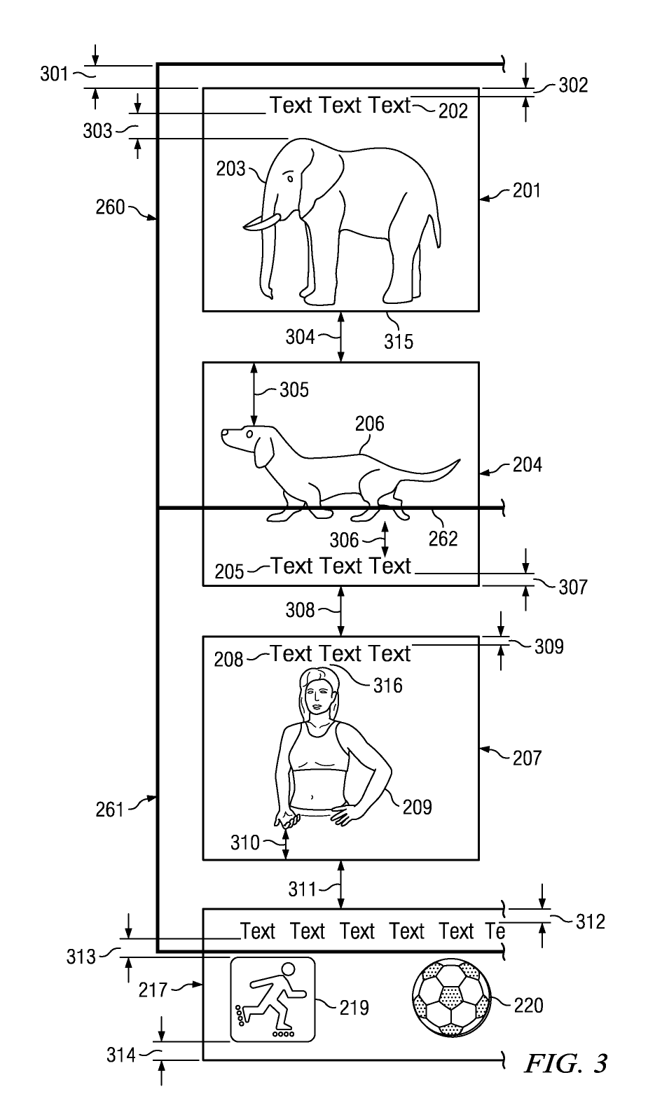

FIG. 3 is a diagram illustrating an example of split region candidates according to an example embodiment. Various information elements of FIG. 2C have been omitted to simplify understanding, but the omission does not limit the invention. The example of FIG. 3 is merely an example of possible split region candidates associated with a part of the example of FIG. 2C, and does not limit the invention. For example, an example embodiment may determine fewer or more split region candidates in similar and/or different relation to information items.

In the example of FIG. 3, split region candidates 301-314 relate to split region candidates associated with a space region. Split region candidates 315 and 316 are associated with a boundary of an information item. Split region candidates 302, 303, and 315 coincide with information item 201. Split region candidates 305-307 coincide with information item 204. Split region candidates 309, 310, and 316 coincide with information item 207. Split region candidates 312-314 coincide with information item 217.

An apparatus may select a split region from one or more split region candidates based, at least in part, on various criteria. In an example embodiment, the apparatus selects a split region based, at least in part, on a split region candidate's proximity to a display boundary, whether a split region candidate is within an information item, how many information items coincide with a split region candidate, the span of any information item that coincides with a split region candidate, the number of adjustments an apparatus would perform for the split region candidate to coincide with a display boundary, and/or the like. Without limiting the invention in any way, technical effects of this selection may be, at least, reducing the number of adjustments performed for the split region to coincide with the display boundary, and reducing the user perception differences between the adjusted information item and the non-adjusted information item.

In an example embodiment, the apparatus selects a split region based, at least in part, on proximity to a display boundary, such as by selecting the split region candidate closest to the display boundary. For example, the apparatus may select split region candidate 306 for a split region based on its proximity to display boundary 262.

In an example embodiment, the apparatus selects a split region based on whether a split region candidate coincides with an information item, such as by selecting a split region candidate that does not coincide with an information item. For example, the apparatus may select split region candidates 301, 304, 306, 308, or 311 for a split region, based, at least in part, on determination that these split region candidates do not coincide with an information item.

In an example embodiment, the apparatus selects a split region based, at least in part, on how many information items coincide with a split region candidate, such as by selecting the split region candidate that coincides with the fewest number of information items. For example, the apparatus may select as a split region, a split region candidate that coincides with a single information item instead of a split region candidate that coincides with two information items. In selecting a split region in accordance with another example, the apparatus may differentiate between a split region candidate coinciding with multiple information items that do not coincide with each other and a split region candidate coinciding with multiple information items where one or more of these information items coincide with each other, such as by selecting the split region candidate that coincides with an information item that does not coincide with another information item. In such an example, the apparatus may select as a split region, a split region candidate coinciding with two adjacent information items instead of a split region candidate coinciding with a first information item and a second information item, where the first information item comprises the second information item.

In an example embodiment, the apparatus selects a split region based, at least in part, on the span of an information item that coincides with a split region candidate. For example, the apparatus may determine that a split region candidate coincides with an information item that spans a greater distance than the distance between the display boundary and a non-adjacent display boundary of the same display boundary region, such as information item 217 of FIG. 2D. Under such circumstances, the apparatus may select as a split region, a split region candidate that coincides with such an information item instead of a split region that does not coincide with the information item.

In an example embodiment, the apparatus selects a split region based, at least in part, on the number and/or magnitude of adjustments an apparatus would perform for the split region candidate to coincide with a display boundary. For example, the apparatus may select as a split region, a split region candidate associated with a lower magnitude of adjustment, such as a split region candidate requiring determined adjustments totaling 100 pixels, instead of a split region candidate associated with determined adjustments totaling 200 pixels. In another example, the apparatus may select a split region candidate associated with a fewer number of adjustments, such as a split region candidate requiring 5 determined adjustments totaling 100 pixels, instead of a split region candidate associated with 2 determined adjustments totaling 100 pixels. In such an example, the apparatus may select the split region so that the 100 pixels of adjustment may be distributed more evenly.

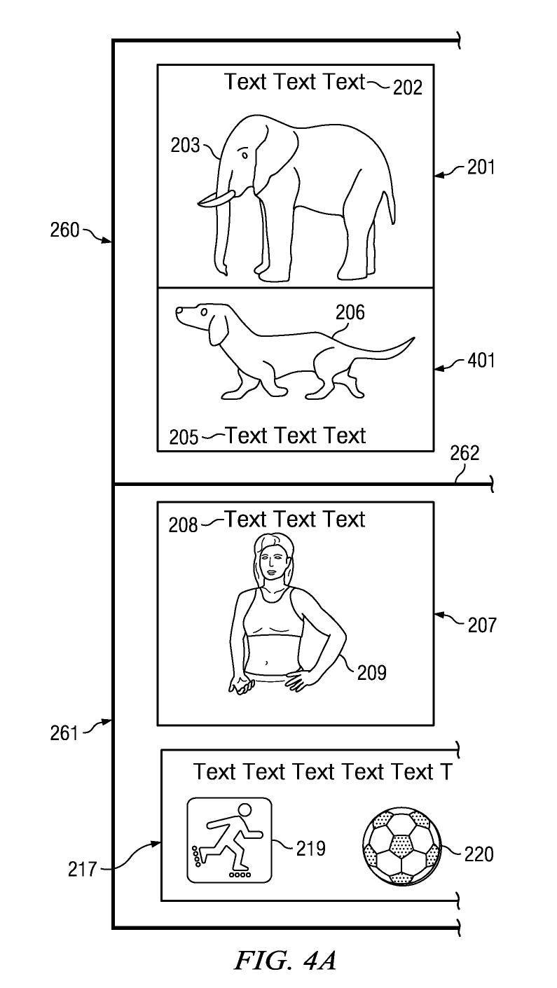

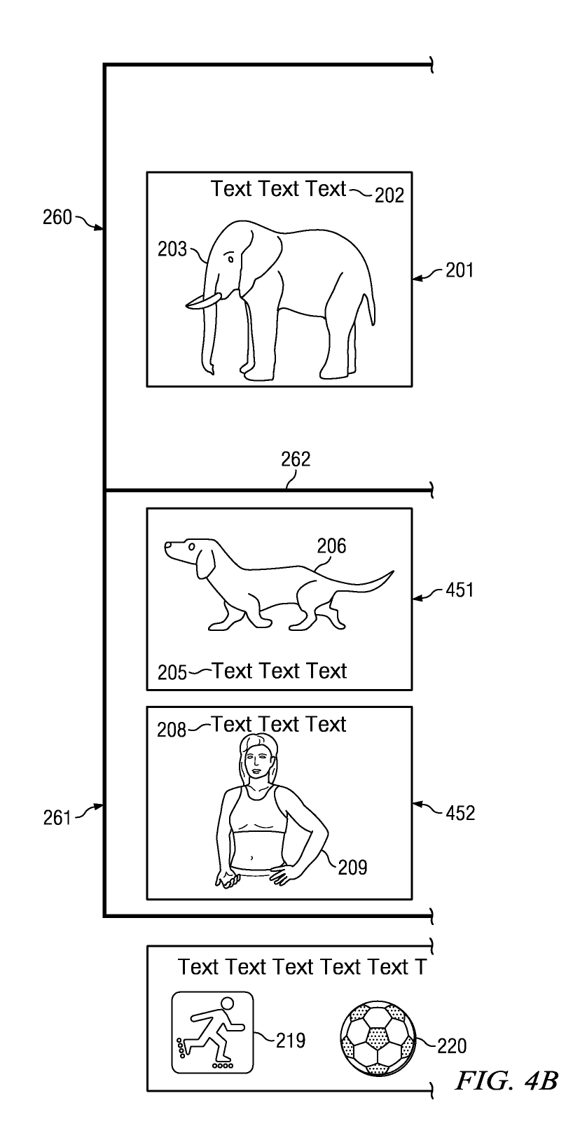

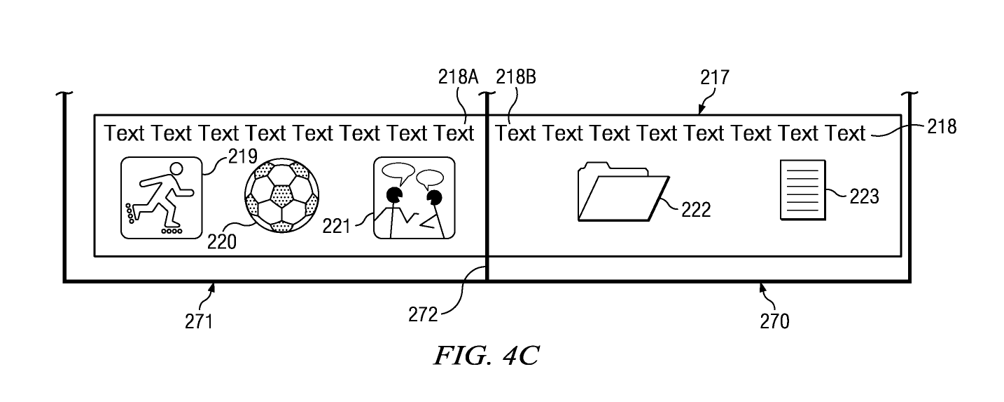

FIGS. 4A-4C are diagrams illustrating examples of adjusted information items according to an example embodiment. The example of FIGS. 4A-4C are merely examples of possible adjustments of information items and do not limit the invention. For example, information items may be adjusted in ways not shown in these examples, such as juxtaposition, adjusting orientation, and/or the like. Even though the examples of FIGS. 4A-4C illustrate adjusted information items in relation to only a part of a plurality of information items, similar adjustment may be applied to other information items.

An apparatus may adjust an information item by modifying a space region, modifying a property of the information item, modifying a different information item, and/or the like. For example, an apparatus may reduce a space region above an information item so that the position of the information item is adjusted upward. In such an example, the space region may be adjacent to the information item or non-adjacent to the information item, for example, if there is an intervening information item between the information item and the space region. For example, between the information item and the space region, there may be a different information item. In another example, an information item may be adjusted by modifying the size of the information item. In such an example, increasing the vertical size of an information item may result in the position of the bottom of the information item being adjusted downward. In still another example, an information item may be adjusted upward by reducing the size of a different information item that is above the information item.

The apparatus may adjust an information item in accordance with a positioning constraint related to a display boundary, such as a border, a correlation between distance between displays and information items, and/or the like. For example, the apparatus may adjust the information item in correlation to a distance between displays associated with a display boundary. In such an example, the information item may be adjusted so that it does not coincide with any region of non-displayed information items due to represented distance between displays. For example, if a region of 100 pixels corresponds to the distance between displays associated with the display boundary, the apparatus may adjust the information item so that it douse not coincide with the 100 pixel region.

FIG. 4A is a diagram illustrating an example of adjusted information items according to an example embodiment. The example of FIG. 4A relates to a part of the example of FIG. 2C associated with selection of a first split region associated with display boundary 262 related to the bottom boundary of information item 204 of FIG. 2C, and second split region associated with the bottom display boundary of display boundary region 261 related to the bottom boundary of information item 217.

In the example of FIG. 4A, information item 401 relates to information item 204 of FIG. 2C after adjustment by an apparatus comprising reducing the space region between the top of image information item 206 and the top of information item 204, reducing the space region between the top of text information item 205 and image information item 206, and reducing the size of information item 204. The apparatus further adjusted information item 401 by removing the space region between information item 201 and information item 401 so that the first split region coincides with the display boundary 262. The apparatus adjusted information item 207 by reducing the space region between information items 207 and 217 so that the second split region coincides with the bottom display boundary region 261.

In the example of FIG. 4A, adjustments of information item 401 adjusted information items 207 and 217, is indicated by their adjusted positions. Therefore, even though no direct adjustment was performed on information item 207, item 207 was adjusted by virtue of its relation to adjusted information item 401.

FIG. 4B is a diagram illustrating an example of adjusted information items according to an example embodiment. The example of FIG. 4B relates to a part of the example of FIG. 2C associated with selection of a first split region associated with display boundary 262 related to the top boundary of information item 201 of FIG. 2C, and split region associated with the bottom display boundary of display boundary region 261 related to the bottom boundary of information item 207 of FIG. 2C.

In the example of FIG. 4B, information item 451 relates to information item 204 of FIG. 2C after adjustment by an apparatus comprising reducing the space region between the top of image information item 206 and information item 204 and reducing the size of information item 204. The apparatus further adjusted information item 401 by increasing the space region above information item 201 and increasing the space region between information item 201 and information item 451 so that the first split region coincides with display boundary 262. Information item 452 relates to information item 207 of FIG. 2C after adjustment by an apparatus comprising reducing the space region between the bottom of information item 209 and the bottom of information item 207 so that the second split region coincides with the bottom display boundary region 261.

In the example of FIG. 4B, adjustments of information item 451 adjusted information items 452 and 217, are indicated by their adjusted positions. Therefore, even though no direct adjustment was performed on information item 217, item 217 was adjusted by virtue of its relation to adjusted information item 451. In addition, adjustment of information item 201 adjusted information items 451, 452, and 217.

FIG. 4C is a diagram illustrating an example of adjusted information items according to an example embodiment. The example of FIG. 4C relates to a part of the example of FIG. 2D associated with selection of a first split region associated with display boundary 272 related to the right boundary of information item 221 and a second split region associated with display boundary 272 related to the right of character information item 218A. In the example of FIG. 4C, the split region may have been selected based, at least in part, on determination that information item 217 spans a greater distance than the distance between the left of display boundary region 217 and display boundary 272.

In the example of FIG. 4C, information items 218A and 218B relate to character information items of text information item 218. An apparatus adjusted text information item 218 by reducing the space region between the left of information item 217 and the left of information item 218, and increasing the space region between character information item 218A and character information item 218B so that the second split region coincides with display boundary 272. Information item 221 was adjusted by reducing the space region between the left of icon information item 219 and the left of information item 217, reducing the space region between icon information item 219 and icon information item 220, and reducing the space region between icon information item 220 and icon information item 221, so that the first split region coincides with display boundary 272. The apparatus further adjusted information item 222 by increasing the space region between icon information item 221, and icon information item 222. The apparatus further adjusted information item 223 by increasing the space region between icon information item 222 and icon information item 223.

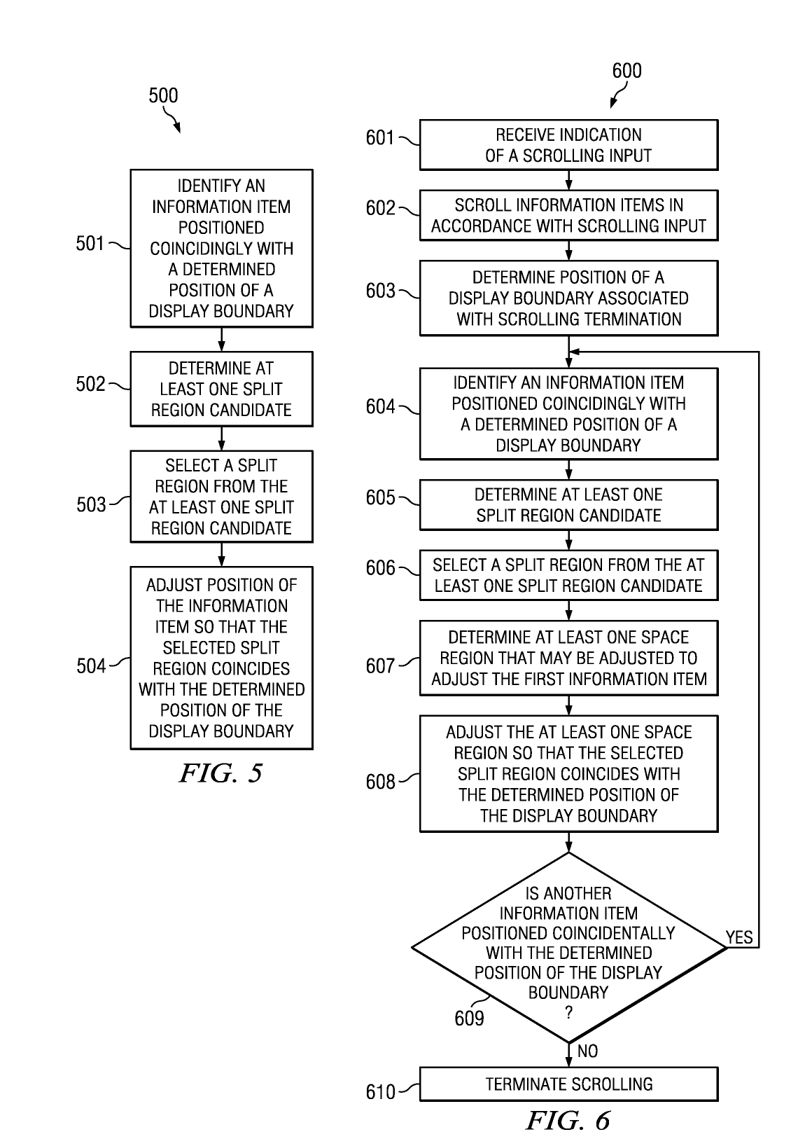

FIG. 5 is a flow diagram showing a set of operations 500 for adjusting an information item according to an example embodiment. An apparatus, for example electronic device 10 of FIG. 7, may utilize the set of operations 500. The apparatus may comprise means, including, for example, the processor 20, for performing the operations of FIG. 5. In an example embodiment, an apparatus, for example device 10 of FIG. 7 is transformed by having memory, for example memory 42 of FIG. 7, comprising computer code configured to, working with a processor, for example processor 20 of FIG. 7, cause the apparatus to perform set of operations 500.

At block 501, the apparatus identifies an information item positioned coincidingly with a determined position of a display boundary. The apparatus may identify the information item based at least in part on information associated with the information item, another information item, and/or the like. For example, the apparatus may identify the information item based, at least in part, on position information associated with the information item. In another example, the apparatus may identify the information item based, at least in part, on size information associated with the information item and position information associated with an adjacent information item. Position of the display boundary may be determined based, at least in part, on a predetermined relationship between the information item and the display boundary, a current relationship between the information item and the display boundary, a determined future relationship between the information item and the display boundary, and/or the like. For example, the display boundary may be determined based, at least in part, on a default location of the display boundary in relation to the information item. In another example, the display boundary may be determined based, at least in part, on a determined scrolling termination position during a scrolling operation. Identification of the information item positioned coincidingly with a determined position of a display boundary may be similar as described with reference to FIGS. 2B-2D.

At block 502, the apparatus determines at least one split region candidate. The at least one split region candidate may relate to a space region, a boundary of the information item, a boundary of a different information item, and/or the like. The split region candidate may be similar as described with reference to FIG. 3.

At block 503, the apparatus selects a split region from the at least one split region candidate. The selection may be similar as described with reference to FIG. 3.

At block 504, the apparatus adjusts position of the information item so that the selected split region coincides with the determined position of the display boundary. Adjusting the position so that the selected split region coincides with the determined position of the display boundary may be similar as described with reference to FIGS. 4A-4C.

Without limiting the claims in any way, a technical effect of set of operations 500 may be providing better user experience by avoiding clipping of information items. Another technical effect may be providing a better user experience by avoiding an information item spanning multiple displays. Another technical effect may be reducing scrolling resulting from a user scrolling back and forth to manually adjust position of information items that coincide with a display boundary.

In an example embodiment, an apparatus may perform a scrolling operation in relation to one or more information items. For example, a user may perform a scrolling input and view the information items panning across the display. In such an example, the apparatus may determine the position of the display boundary associated with scrolling termination upon receiving the scrolling input, during scrolling, prior to scrolling termination, upon scrolling termination, and/or the like. The user may perform multiple concurrent scrolling operations prior to termination of scrolling, such as iterative kinetic scrolling operations. In such a circumstance, the apparatus may determine position of the display boundary associated with scrolling termination upon each scrolling input, after the last scrolling input, at a determined time during the scrolling, prior to scrolling termination, upon scrolling termination, and/or the like.

FIG. 6 is a flow diagram showing a set of operations 600 for adjusting an information item according to an example embodiment. An apparatus, for example electronic device 10 of FIG. 7, may utilize the set of operations 600. The apparatus may comprise means, including, for example, the processor 20, for performing the operations of FIG. 6. In an example embodiment, an apparatus, for example device 10 of FIG. 7 is transformed by having memory, for example memory 42 of FIG. 7, comprising computer code configured to, working with a processor, for example processor 20 of FIG. 7, cause the apparatus to perform set of operations 600.

At block 601, the apparatus receives indication of a scrolling input. The apparatus may receive indication of the scrolling input by retrieving information from one or more memories, such as non-volatile memory 42 of FIG. 7, receiving one or more indications of the scrolling input from a part of the apparatus, such as a touch display, for example display 28 of FIG. 7, receiving indication of the scrolling input from a receiver, such as receiver 16 of FIG. 7, receiving scrolling input from a keypad, such as keypad 30 of FIG. 7, and/or the like. In an example embodiment, the apparatus may receive the indication of the scrolling input from a different apparatus, such as a mouse, a keyboard, an external touch display, and/or the like. The scrolling input relates to an input that the apparatus associates with scrolling.

At block 602, the apparatus scrolls information items in accordance with the scrolling input. The scrolling of information items may relate to progressive scrolling, kinetic scrolling, and/or the like.

At block 603, the apparatus determines position of the display boundary associated with scrolling termination. For example, the apparatus may calculate a region comprising one or more information items in relation to, at least, the position of the display boundary when the indication of the scrolling input was received and the indication of the scrolling input. In such an example, the indication of the scrolling input may relate to kinetic scrolling and the apparatus may determine the position that the display boundary should have when scrolling terminates. Without limiting the scope of the claims, a technical effect of determining the position of the display boundary associated with scrolling termination may be, at least, reducing the number of operations performed by the apparatus upon termination of scrolling, and allowing the apparatus to adjust position of the first information item prior to scrolling termination.

At block 604, the apparatus identifies an information item positioned coincidingly with a determined position of a display boundary. Identification of the information item positioned coincidingly with a determined position of a display boundary may be similar as described with reference to block 501 of FIG. 5.

At block 605, the apparatus determines at least one split region candidate. The split region candidate may be similar as described with reference to block 502 of FIG. 5.

At block 606, the apparatus selects a split region from the at least one split region candidate. The selection may be similar as described with reference to block 503 of FIG. 5.

At block 607, the apparatus identifies at least one space region that may be adjusted to adjust position of the first information item. The space region may be similar as described with reference to FIG. 1.

At block 608, the apparatus adjusts the at least one space region so that the selected split region coincides with the determined position of the display boundary. Adjusting the position so that the selected split region coincides with the determined position of the display boundary may be similar as described with reference to block 504 of FIG. 5.

At block 609, the apparatus determines whether another information item is positioned coincidingly with the determined position of the display boundary. The determination may relate to evaluating at least one information element comprised in the first information item, adjacent to the first information item, near the first information item, far from the first information item, and/or the like. If the apparatus determines that there is another information item positioned coincidingly with the determined position of the display boundary, the flow proceeds to block 604. Otherwise, the flow proceeds to block 610.

At block 610, the apparatus terminates scrolling.

FIG. 7 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing circuitry that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1-6. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1-6. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1-6. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1-7. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoresistive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 7 illustrates an example of an electronic device that may utilize embodiments of the invention including those described and depicted, for example, in FIGS. 1-6, electronic device 10 of FIG. 7 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 7. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 602 of FIG. 6 may be performed after block 603. In another example, block 610 of FIG. 6 may be performed prior to block 604 of FIG. 6. Furthermore, if desired, one or more of the above-described functions may be optional or may be combined. For example, block 607 of FIG. 6 may be optional or combined with block 608 of FIG. 6.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1. An apparatus, comprising:
a processor;
memory including computer program code, the memory and the computer program code configured to, working with the processor, cause the apparatus to perform at least the following:
identify a first information item positioned coincidingly with a determined position of a display boundary;
determine at least one split region candidate;
select a split region from the at least one split region candidate; and
adjust position of the first information item so that the selected split region coincides with the determined position of the display boundary.

2. The apparatus of claim 1, wherein the display boundary relates to a boundary between a plurality of displays.

3. The apparatus of claim 1, wherein the first information item comprises a plurality of information items.

4. The apparatus of claim 1, wherein selection of the split region is based at least in part on proximity of the split region to the display boundary.

5. The apparatus of claim 1, wherein selection of the split region is based at least in part on determination that the split region does not coincide with an information item.

6. The apparatus of claim 1, wherein selection of the split region is based at least in part on evaluation of the number of information items coinciding with the split region.

7. The apparatus of claim 1, wherein selection of the split region is based at least in part on a determination that an information item coinciding with the split region spans a greater distance than the distance between the display boundary and a non-adjacent display boundary of a common display boundary region.

8. The apparatus of claim 1, wherein selection of the split region is based at least in part on evaluation of the adjustments associated with adjusting position of the first information item so that the split region coincides with the determined position of the display boundary.

9. The apparatus of claim 1, wherein the at least one split region candidate relates to at least one space region.

10. The apparatus of claim 1, wherein the at least one split region candidate relates to at least one boundary of the first information item.

11. The apparatus of claim 1, wherein the memory and computer program code are further configured to, working with the processor, cause the apparatus to perform at least identifying at least one space region that may be adjusted to adjust position of the first information item.

12. The apparatus of claim 11, wherein adjusting of the first information item comprises adjusting the identified at least one space region.

13. The apparatus of claim 1, wherein adjusting position of the first information item comprises adjusting a second information item that is not comprised by the first information item.

14. The apparatus of claim 1, wherein the memory and computer program code are further configured to, working with the processor, cause the apparatus to perform at least receiving indication of a scrolling input.

15. The apparatus of claim 14, wherein the memory and computer program code are further configured to, working with the processor, cause the apparatus to perform at least scrolling information items in accordance with the scrolling input.

16. The apparatus of claim 1, wherein the memory and computer program code are further configured to, working with the processor, cause the apparatus to perform at least determining position of the display boundary associated with scrolling termination.

17. The apparatus of claim 16, wherein the determination of the display boundary is performed prior to scrolling termination.

18. The apparatus of claim 1, wherein the apparatus comprises a plurality of displays.

19. A method, comprising:
identifying with a processor a first information item positioned coincidingly with a determined position of a display boundary;
determining with a processor at least one split region candidate;
selecting with a processor a split region from the at least one split region candidate; and
adjusting with a processor position of the first information item so that the selected split region coincides with the determined position of the display boundary.

20-52. (canceled)

53. A computer-readable medium encoded with instructions that, when executed by a computer, perform:
identifying a first information item positioned coincidingly with a determined position of a display boundary;
determining at least one split region candidate;
selecting a split region from the at least one split region candidate; and
adjusting position of the first information item so that the selected split region coincides with the determined position of the display boundary.

54-70. (canceled)
